(19) United States
(12) Patent Application Publication
(10) Pub. No.: US 2004/0217844 A1
(43) Pub. Date: Nov. 4, 2004

(54) Thick film thermistor and method of manufacture

(76) Inventors: Robert Podoloff, Framingham, MA (US); Robert B. Goldman, Evanston, IL (US)

Correspondence Address: KEY SAFETY SYSTEMS, INC., PATENT DEPARTMENT, 5300 ALLEN K BREED HIGHWAY, LAKELAND, FL, 33811-1130, US

(21) Appl. No.: 10/822,763

(22) Filed: Apr. 13, 2004

Related U.S. Application Data
(60) Provisional application No. 60/465,270, filed on Apr. 25, 2003.

(51) Int. Cl. H01C 7/10

(52) U.S. Cl. 338/22 R; 338/47

(57) ABSTRACT

The design of a thermistor maximizes the temperature sensitive effects of the semiconductive inks while minimizing or eliminating the force sensitive effects. The design provides for an integrated force and temperature sensor having reduced costs, improved sensitivity and reproducibility, and greater reliability. A thick film thermistor has (a) a pair of shaped electrical conductors deposited on a first support substrate; (b) a temperature sensitive ink layer deposited over the pair of electrical conductors so that the ink layer is coextensive with the pair of electrical conductors; and (c) a second support substrate bonded to the first support substrate.

### FIELD OF THE INVENTION

The invention relates generally to temperature sensing devices for temperature compensation and, more particularly, to a thick film thermistor device for force sensor compensation and its method of manufacture.

### BACKGROUND OF THE INVENTION

Thermistors are electrical resistors made of semiconductor material, whose resistance varies in a known manner with temperature. They may be manufactured by thick or thin film techniques that are known in the art. These techniques involve depositing a temperature sensitive resistive material on a substrate and firing the combination at a relatively high temperature. Sintering and sputtering techniques are sometimes used in the manufacturing process. Thick film thermistors are usually manufactured by screening resistive and conductive materials onto a substrate which are then heated to a high temperature to fix the electrical characteristics and to bond the materials to the substrate. Since the resistance values of the final product normally exhibit a wide variation, laser trimming or similar techniques are used to adjust the resistance value of the temperature sensing material.

Force sensors have been produced by various techniques, and include piezoelectric devices, semiconductor devices, capacitive devices and conductive ink film devices. The conductive ink devices typically employ a pair of thin support substrates with one or more conductive ink electrodes on each support substrate facing each other. A force sensitive semiconductive material is deposited over the facing electrodes and the pair of support substrates are bonded to each other. The electrodes are electrically connected to electronic circuitry, which measures the change in resistance or conductivity of the device due to applied force on the support substrates. The conductivity increases with applied force in a determinable manner. Semiconductive materials used in force sensing devices are described in U.S. Pat. No. 4,856,933 and U.S. Pat. No. 5,296,837. The use of particulate conductive materials in force sensors are also described in U.S. Pat. No. 5,302,936. A force sensor may be made by depositing a semiconductive ink by spraying or silk screening a thin layer onto a pair of flexible support substrates having conductive electrodes. When the ink dries, the pair of support substrates are bonded together to form a force sensor. However, force sensors manufactured by this method have a conductance that increases with temperature. Extensive testing of force sensors has shown a significant shift in the sensitivity of the device with temperature. Although it is possible to compensate for these effects through conditioning electronics, the task would be greatly simplified by finding a resistive temperature device which ideally matches the shift in sensitivity of the force sensor.

In order to compensate for an increase in conductance with temperature in force sensors manufactured with semiconductive ink, discrete temperature sensing devices, such as thermistors, are often positioned in close proximity with the force sensor. In this manner, electronic circuitry that determines the applied force value by measuring conductance of the force sensor may also compensate the applied force value for changes in ambient temperature by measuring the conductance of the thermistor. There are a number of shortcomings to this technique. One disadvantage is the limited temperature range of most semiconductive materials used in force sensors. Most force sensors made with semiconductive ink are limited to a maximum useful temperature of between 120° F. and 150° F. Another disadvantage is that there may be changes in electrical characteristics of the force sensor and the thermistor over time or between production runs. This results in increased manufacturing costs due to increased calibration time during initial setup. Yet another disadvantage is that the temperature sensing thermistor and the force sensor are not integrated as a unified manufactured assembly. That is, the thermistor is a discrete device that must be mounted and connected separately from the force sensor. This also results in increased manufacturing costs.

For the foregoing reasons, it is desirable to have an integrated force and temperature sensor having reduced costs, improved sensitivity, reproducibility, and reliability. It is desirable to have an integrated force and temperature sensor that are manufactured from the same process that would enable the electrical characteristics of each device to track the other. For example, it is desirable to have the temperature coefficients and the ratio of the conductances be the same over the life of the devices in order to reduce the cost of initial calibration and eliminate field maintenance. It would also reduce manufacturing costs and increase reliability because of the elimination of the separate thermistor and associated mounting requirements. It is also desirable to provide reliable and repeatable operation of the devices up to an ambient temperature of 350° F.

### SUMMARY OF THE INVENTION

The present invention is directed to a device and method of manufacture that satisfies these needs. The present invention provides for an integrated force and temperature sensor having reduced costs, improved sensitivity, reproducibility, and reliability. It may be configured to satisfy many different application configurations at ambient temperatures of up to 305° F. Reduced costs and increased reliability are achieved by the elimination of components and associated labor, and by a reduction in initial product setup time because of increased consistency between the electrical characteristics of the force and temperature sensor. Using the same silver based conductive and semiconductive resistive inks as that in force sensors, the present invention is designed to maximize the temperature sensitive effects of the semiconductive inks while minimizing or eliminating the force sensitive characteristics.

In accordance with the present invention, an improved high temperature, carbon free, force and temperature sensing ink is deposited in a thin layer over one or more electrical conductors, where the conductors are mounted on a flexible support substrate. Two such support substrates are bonded together in a sandwich configuration to provide an integrated force and temperature sensor capable of operation at temperatures up to 350° F. The force and temperature sensing ink is described in U.S. Pat. No. 5,541,570 and comprises a high temperature binder, intrinsically semiconductive particles and conductive particles. The conductive particles preferably comprise a conductive metal oxide compound that deviates from stoichiometry based on an oxygen value of two. Preferably, the conductive oxide particles are conductive tin oxide particles, Fe₃O₄ iron oxide particles or mixtures thereof.

The force and temperature sensing ink may include dielectric particles, such as silica having a particle size of 10 microns or less. The semiconductive particles are preferably molybdenum disulfide particles. The particles in the ink are preferably of a particle size of 10 microns or less (and most preferably no more than about 1 micron in average size) and the high temperature binder is a thermoplastic polyimide resin. In a preferred form, the conductive and semiconductive particles are present in a combined concentration of from at least 20% by volume to 80% by volume of the dried ink when deposited in a thin layer, and the binder is present in a combined amount of from 20% to 80% by volume.

Preferably, the force and temperature ink comprises semiconductive particles that are molybdenum disulfide particles and the semiconductive and conductive particles are of an average size of 1.0 micron or less. It is desirable that the binder is a thermoplastic polyimide binder and the conductive and semiconductive particles are present in the amount of at least 20% by volume and less than 80% by volume of the dried ink when deposited in a thin layer. In another preferred form, the binder is present in a combined amount of from 20% to 80% by volume and the conductive and semiconductive particles are present in a combined amount of from 80% to 20% by volume.

A thick film thermistor having features of the present invention comprises a pair of shaped electrical conductors deposited on a first support substrate, a temperature sensitive ink layer deposited over the pair of electrical conductors so that the ink layer is coextensive with the pair of electrical conductors, and a second support substrate bonded to the first support substrate. The temperature sensitive ink layer may comprise a high temperature, carbon-free temperature sensing ink layer. The temperature sensing ink layer may comprise a high temperature ink binder, intrinsically semiconductive particles, and conductive particles comprising a conductive metal oxide compound based on an oxygen value of two. The temperature sensitive ink layer may comprise conductive particles having a mixture of conductive tin oxide particles and Fe₃O₄ iron oxide particles, and further comprises dielectric particles. The pair of shaped electrical conductors may comprise deposited shaped, silver based conductive ink patterns. Each conductor of the pair of shaped electrical conductors may be shaped in an interdigitated manner with the other electrical conductor. A resistance value of the thermistor may be determined by a surface area of the pair of shaped electrical conductors and a resistivity of the temperature sensitive ink layer. The first support substrate and the second support substrate may comprise a flexible film substrate. The pair of shaped electrical conductors may be connected to resistance measuring circuitry for temperature compensation.

In an alternate embodiment of the invention, a method of manufacturing a thick film thermistor comprises the steps of depositing a pair of shaped electrical conductors on a first support substrate, depositing a temperature sensitive ink layer over the pair of electrical conductors so that the ink layer is coextensive with the pair of electrical conductors, and bonding a second support substrate to the first support substrate. The temperature sensitive ink layer may comprise a high temperature, carbon-free temperature sensing ink layer. The temperature sensitive ink layer may comprise a high temperature ink binder, instrinsically semiconductive particles, and conductive particles comprising a conductive metal oxide compound based on an oxygen value of two. The temperature sensitive ink layer may comprise conductive particles having a mixture of conductive tin oxide particles and Fe₃O₄ iron oxide particles, and further comprises dielectric particles. The step of depositing the pair of shaped electrical conductors may comprise depositing shaped, silver based conductive ink patterns. The step of depositing a pair of shaped electrical conductors may comprise the step of depositing each conductor of the pair of shaped electrical conductors in an interdigitated manner with the other electrical conductor. A resistance value of the thermistor may be determined by adjusting a surface area of the pair of shaped electrical conductors and a resistivity of the temperature sensitive ink layer. The first support substrate and the second support substrate may comprise flexible film substrates.

In another alternate embodiment, a thick film thermistor comprises a pair of shaped thermistor electrical conductors deposited on a first support substrate, a first shaped force sensor electrical conductor deposited on the first support substrate, a second shaped force sensor electrical conductor deposited on a second support substrate, the second shaped force sensor electrical conductor forming a mirror image of the first shaped force sensor electrical conductor, a first pressure and temperature sensitive ink layer deposited over the pair of shaped thermistor electrical conductors so that the ink layer is coextensive with the pair of thermistor electrical conductors, a second force and temperature sensitive ink layer deposited over the first shaped force sensor electrical conductor so that the ink layer is coextensive with the first shaped force sensor electrical conductor, a third force and temperature sensitive ink layer deposited over the second shaped force sensor electrical conductor so that the ink layer is coextensive with the second shaped force sensor electrical conductor, and the second support substrate being bonded to the first support substrate so that the second sensitive ink layer is coextensive with the third sensitive ink layer, and the first shaped force sensor electrical conductor is aligned in a mirror image manner with the second shaped force sensor electrical conductor. The force and temperature sensitive ink layers may comprise a high temperature ink binder, intrinsically semiconductive particles, and conductive particles comprising a conductive metal oxide compound based on an oxygen value of two. The electrical conductors may comprise deposited shaped silver based conductive ink patterns. Each conductor of the pair of shaped thermistor electrical conductors may be shaped in an interdigitated manner with the other electrical conductor. The first support substrate and the second support substrate may comprise a flexible film substrate. The pair of shaped thermistor electrical conductors may be connected to resistance measuring circuitry for temperature compensation, and the first shaped force sensor electrical conductor and the second shaped force sensor electrical conductor may be connected to resistance measuring circuitry for force determination.

In yet another embodiment of the presentation, a method of manufacturing a thick film thermistor comprises the steps of depositing a pair of shaped thermistor electrical conductors on a first support substrate, depositing a first shaped force sensor electrical conductor on the first support substrate, depositing a second shaped force sensor electrical conductor on a second support substrate, the second shaped force sensor electrical conductor forming a mirror image of the first shaped force sensor electrical conductor, depositing a first force and temperature sensitive ink layer over the pair of shaped thermistors electrical conductors so that the ink layer is coextensive with the pair of thermistor electrical conductors, depositing a second force and temperature sensitive ink layer over the first shaped force sensor electrical conductor, depositing a third force and temperature sensitive ink layer over the second shaped force sensor electrical conductor so that the ink layer is coextensive with the second shaped force sensor electrical conductor, and bonding the second support substrate to the first support substrate so that the second sensitive ink layer is coextensive with the third sensitive ink layer, and the first shaped force sensor electrical conductor is aligned in a mirror image manner with the second shaped force sensor electrical conductor. The force and temperature sensitive ink layers may comprise a high temperature ink binder, intrinsically semiconductive particles, and conductive particles comprising a conductive metal oxide compound based on an oxygen value of two. The step of the depositing the shaped electrical conductors may comprise depositing shaped, silver based conductive ink patterns. The step of depositing a pair of shaped thermistor electrical conductors may comprise the step of depositing each conductor of the pair of shaped thermistor electrical conductors in an interdigitated manner with the other electrical conductor. The first support substrate and the second support substrate may comprise flexible film substrates.

The present invention provides for an integrated force and temperature sensor having reduced costs, improved sensitivity, reproducibility, and reliability. It may be configured to satisfy many different application configurations at ambient temperatures of up to 350° F. Reduced costs and increased reliability are achieved by the elimination of components and associated labor, and by a reduction in initial product setup time because of increased consistency between the electrical characteristics of the force and temperature sensor.

### BRIEF DESCRIPTION OF THE DRAWINGS

These and other features, aspects, and advantages of the present invention will become better understood with regard to the following description, appended claims, and accompanying drawings where:

FIG. 1 shows the conductance characteristics of a typical force sensitive resistive device over a normal range of applied force at three operating temperatures.

FIG. 2 shows the temperature variation of the conductance of a force sensor and the temperature variation of the conductance of a thick film thermistor manufactured by the same process.

FIG. 3 shows a typical configuration of the construction of a thick film thermistor.

FIG. 4 shows a configuration of a force sensor integrated with a thick film thermistor, both manufactured using the same materials and process.

### DETAILED DESCRIPTION OF THE INVENTION

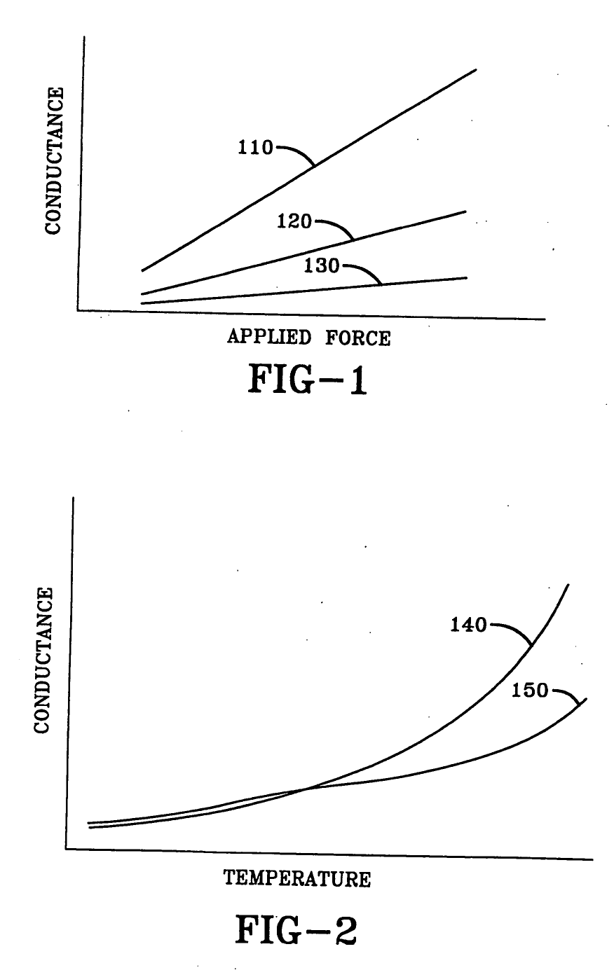

Turning now to FIG. 1, FIG. 1 shows the conductance characteristics of a typical force sensitive resistive sensor over a normal range of applied force at three operating temperatures. These curves depict the effective change in the sensitivity or gain with temperature. The upper curve 110 depicts the variation of the conductance with applied force from about 1.0 Kg to about 5.0 Kg at a temperature of 85° C. The middle curve 120 depicts the variation of conductance with applied force from about 1.0 Kg to about 5.0 Kg at a temperature of 25° C. The lower curve 130 depicts the variation of conductance with applied force from about 1.0 Kg. to about 5.0 Kg at a temperature of −40° C. These curves demonstrate the sensitivity of the conductance characteristics due to temperature change. To compensate for this temperature sensitivity, the gain of an amplifier whose input is connected to the force sensor could be adjusted to make these curves coincide with one another, thus compensating for the variation in conductance (resistance) with temperature. Note that with no preload force, these three curves would have zero conductance at zero applied force, and therefore, pass through the origin. Note that while the exact magnitude of the temperature effect on the force sensing device is dependent upon many factors, including sensor geometry, ink blend, ink deposition, manufacturing tolerances, etc., the effect has been found to be very repeatable for any given sensor.

Turning now to FIG. 2, FIG. 2 shows the temperature variation of the conductance of a force sensor and the temperature variation of the conductance of a thick film thermistor manufactured by the same process. The curve 140 depicts the temperature variation of the conductance of a force sensor under a load of approximately 0.9 Kg over a temperature range of from −40° to 85° C. The curve 150 depicts the temperature variation of the conductance of a thick film thermistor over a temperature range of from −40° C. to 85° C. These curves show the similarity of the temperature characteristics of the two devices.

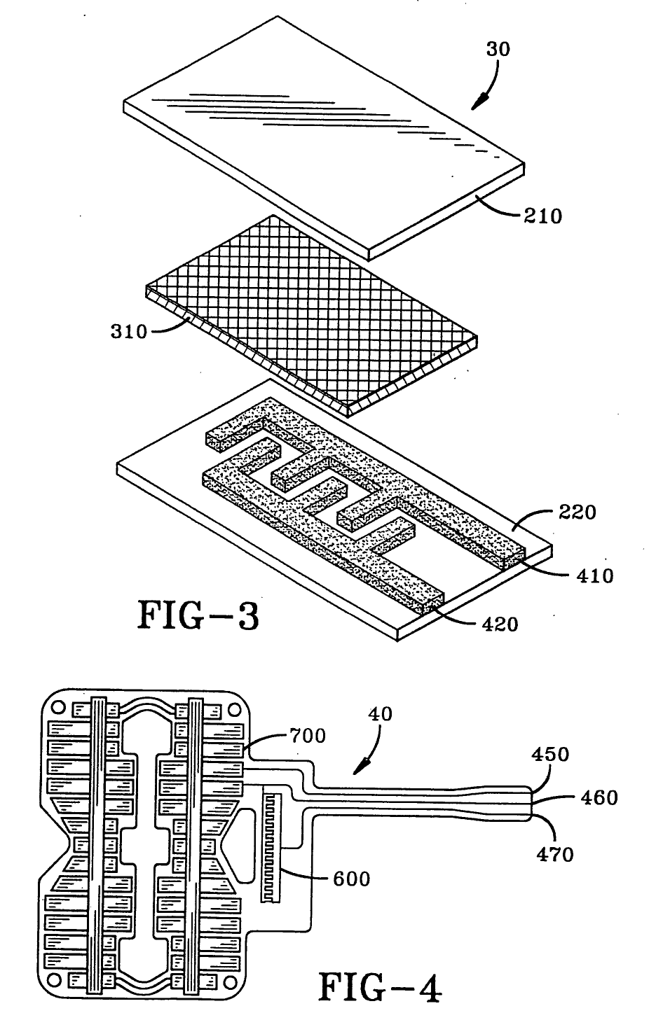

Turning now to FIG. 3, a preferred embodiment of the device 30, is shown in accordance with the present inventive concepts. FIG. 3 shows a typical configuration of the construction of a thick film thermistor. The device 30 comprises a pair of shaped electrical conductors 410, 420 on a first support substrate 220. The first support substrate 220 may be a flexible insulating film such as a polyester or polyimide film. The pair of shaped electrical conductors 410, 420 may typically be 0.00025 inch thick silver ink traces. A temperature sensitive ink layer 310 is deposited over the pair of electrical conductors 410, 420. This temperature sensitive ink layer 310 may typically be a 0.0005 inch thick semiconductive ink layer. A second support substrate 210 is bonded to the first support substrate 220. The second support substrate 210 may also be a flexible insulating film such as a polyester or polyimide film. This thermistor 30 is designed to eliminate the fore-sensitive nature of the inks by eliminating the semiconductive to semiconductive mechanical interface which is the major contributor to the force-conductance interaction of the devices. By printing the semiconductive ink layer 310 on top of the shaped conductors 410, 420, the region of the force sensing contract interface is removed. The interdigitated conductor pattern shown is intended to increase the contact length between the conductors and the semiconductive ink while minimizing overall sensor size. The desire for a relatively long contact length is influenced by the relatively high overall impedance of the ink itself. Sensors may be manufactured using several ink blends on several different sensor geometries in which the number and width of the interdigitated conductor fingers were varied. These sensors perform independently of the force applied to their surfaces and exhibit the expected response. Although the sensitivities of the sensors to changes in temperature varied greatly with the different ink blends and geometries, all of the sensors exhibited performance which could be characterized by a straight line in a semi-log plot of resistance versus temperature.

Turning now to FIG.4, an alternate embodiment of the device 40 is shown in accordance with the present inventive concepts. FIG. 4 shows a configuration of a force sensor integrated with a thick film thermistor, both manufactured using the same materials and process. FIG. 4 depicts a force sensing region 700 that comprises sandwiched layers of a first support substrate on which a first shaped force sensor conductor is deposited. A connecting point 450 is provided for the first shaped force sensor conductor. A second layer of force and temperature sensitive material is deposited over the first shaped sensor conductor. A mirror image of this configuration that comprises a second support substrate, a second shaped force sensor conductor, and a third layer of force and temperature sensitive material is bonded to the first support substrate such that the second and the third force and temperature sensitive layers are in contact with and coextensive with each other. Also included is the temperature sensing region 600 that comprises a pair of shaped thermistor conductor deposited on the first support substrate and a first force and temperature sensitive layer deposited over the pair of shaped thermistor conductors. The second support substrate covers the first force and temperature sensitive layer when it is bonded to the first support substrate. A common connecting point 460 is provided for the second shaped force sensor conductor and one of the elements of the pair of shaped thermistor conductors. A connecting point 470 is provided for the other element of the pair of shaped thermistor conductors. The first and the second support substrates may be flexible insulting substrates such as polyester or polyimide film. The force and temperature sensitive layers may be 0.0005 inch thick semiconductive ink layers. The conductors may be 0.00025 inch thick silver ink traces.

Although the present invention has been described in considerable detail with reference to certain preferred embodiments there of, other embodiments are possible. Therefore, the spirit and scope of the appended claims should not be limited to the description of the preferred embodiments herein.

What is claimed is:

1. A thick film thermistor comprising:
(a) a pair of shaped electrical conductors deposited on a first support substrate;
(b) a temperature sensitive ink layer deposited over the pair of electrical conductors so that the ink layer is coextensive with the pair of electrical conductors; and
(c) a second support substrate bonded to the first support substrate.

2. The thick film thermistor according to claim 1 wherein the temperature sensitive ink layer comprises a high temperature, carbon-free temperature sensing ink layer.

3. The thick film thermistor according to claim 1 wherein the temperature sensing ink layer comprises:
(a) a high temperature ink binder;
(b) intrinsically semiconductive particles; and
(c) conductive particles comprising a conductive metal oxide compound based on an oxygen value of two.

4. The thick film thermistor according to claim 3 wherein the temperature sensitive ink layer comprises conductive particles having a mixture of conductive tin oxide particles and Fe₃O₄ iron oxide particles, and further comprises dielectric particles.

5. The thick film thermistor according to claim 1 wherein the pair of shaped electrical conductors comprise deposited shaped, silver based conductive ink patterns.

6. The thick film thermistor according to claim 1 wherein each conductor of the pair of shaped electrical conductors is shaped in an interdigitated manner with the other electrical conductor.

7. The thick film thermistor according to claim 1 wherein a resistance value of the thermistor is determined by a surface area of the pair of shaped electrical conductors and a resisitivity of the temperature sensitive ink layer.

8. The thick film thermistor according to claim 1 wherein the first support substrate and the second support substrate comprises a flexible film substrate.

9. The thick film thermistor according to claim 1 wherein the pair of shaped electrical conductors are connected to resistance measuring circuitry for temperature compensation.

10. A method of manufacturing a thick film thermistor, comprising the steps of:
(a) depositing a pair of shaped electrical conductors on a first support substrate;
(b) depositing a temperature sensitive ink layer over the pair of electrical conductors so that the ink layer is coextensive with the pair of electrical conductors; and
(c) bonding a second support substrate to the first support substrate.

11. The method of manufacturing a thick film thermistor according to claim 10 wherein the temperature sensitive ink layer comprises a high temperature, carbon-free temperature sensing ink layer.

12. The method of manufacturing a thick film thermistor according to claim 10 wherein the temperature sensitive ink layer comprises:
(a) a high temperature ink binder;
(b) intrinsically semi-conductive particles; and
(c) conductive particles comprising a conductive metal oxide compound based on an oxygen value of two.

13. The method of manufacturing a thick film thermistor according to claim 12 wherein the temperature sensitive ink layer comprises conductive particles having a mixture of conductive tin oxide particles and Fe₃O₄ iron oxide particles, and further comprises dielectric particles.

14. The method of manufacturing a thick film thermistor according to claim 10 wherein the step of depositing the pair of shaped electrical conductors comprises depositing shaped, silver based conductive ink patterns.

15. The method of manufacturing a thick film thermistor according to claim 10 wherein the step of depositing a pair of shaped electrical conductors comprises the step of depositing each conductor of the pair of shaped electrical conductors in an interdigitated manner with the other electrical conductor.

16. The method of manufacturing a thick film thermistor according to claim 10 wherein a resistance value of the thermistor is determined by adjusting a surface are of the pair of shaped electrical conductors and a resistivity of the temperature sensitive ink layer.

17. The method of manufacturing a thick film thermistor according to claim 10 wherein the first support substrate and the second support substrate comprise flexible film substrates.

18. A thick film thermistor, comprising:
(a) a pair of shaped thermistor electrical conductors deposited on a first support substrate;
(b) a first shaped force sensor electrical conductor deposited on the first support substrate;
(c) a second shaped force sensor electrical conductor deposited on a second support substrate, the second shaped force sensor electrical conductor forming a mirror image of the first shaped force sensor electrical conductor;
(d) a first force and temperature sensitive ink layer deposited over the pair of shaped thermistor electrical conductors so that the ink layer is coextensive with the pair of thermistor electrical conductors;
(e) a second force and temperature sensitive ink layer deposited over the first shaped force sensor electrical conductor so that the ink layer is coextensive with the first shaped force sensor electrical conductor;
(f) a third force and temperature sensitive ink layer deposited over the second shaped force sensor electrical conductor so that the ink layer is coextensive with the second shaped force sensor electrical conductor; and
(g) the second support substrate being bonded to the first support substrate so that the second sensitive ink layer is coextensive with the third sensitive ink layer, and the first shaped force sensor electrical conductor is aligned in a mirror image manner with the second shaped force sensor electrical conductor.

19. The thick film thermistor according to claim 18 wherein the force and temperature sensitive ink layers comprise:
(a) a high temperature ink binder;
(b) intrinsically semiconducitve particles; and
(c) conductive particles comprising a conductive metal oxide compound base on an oxygen value of two.

20. The thick film thermistor according to claim 18 wherein the electrical conductors comprise deposited shaped silver based conductive ink patterns.

21. The thick film thermistor according to claim 18 wherein each conductor of the pair of shaped thermistor electrical conductors is shaped in an interdigitated manner with the other electrical conductor.

22. The thick film thermistor according to claim 18 wherein the first support substrate and the second support substrate comprise a flexible film substrate.

23. The thick film thermistor according to claim 18 wherein: the pair of shaped thermistor electrical conductors are connected to resistance measuring circuitry for temperature compensation; and the first shaped force sensor electrical conductor and the second shaped force sensor electrical conductor are connected to resistance measuring circuitry for force determination.

24. A method of manufacturing a thick film thermistor, comprising the steps of:
(a) depositing a pair of shaped thermistor electrical conductors on a first support substrate;
(b) depositing a first shaped force sensor electrical conductor on the first support substrate;
(c) depositing a second shaped force sensor electrical conductor on a second support substrate, the second shaped force sensor electrical conductor forming a mirror image of the first shaped force sensor electrical conductor;
(d) depositing a first force and temperature sensitive ink layer over the pair of shaped thermistor electrical conductors so that the ink layer is coextensive with the pair of thermistor electrical conductors;
(e) depositing a second force and temperature sensitive ink layer over the first shaped force sensor electrical conductor so that the ink layer is coextensive with the first shaped force sensor electrical conductor;
(f) depositing a third force and temperature sensitive ink layer over the second shaped force sensor electrical conductor so that the ink layer is coextensive with the second shaped force sensor electrical conductor; and
(g) bonding the second support substrate to the first support substrate so that the second ink layer is coextensive with the third sensitive ink layer, and the first shaped force sensor electrical conductor is aligned in a mirror image manner with the second shaped force sensor electrical conductor.

25. The method of manufacturing a thick film thermistor according to claim 24 wherein the force and temperature sensitive ink layers comprise:
(a) a high temperature ink binder;
(b) intrinsically semiconductive particles; and
(c) conductive particles comprising a conductive metal oxide compound based on an oxygen value of two.

26. The method of manufacturing a thick film thermistor according to claim 24 wherein the step of depositing the shaped electrical conductors comprises depositing shaped, silver based conductive ink patterns.

27. The method of manufacturing a thick film thermistor according to claim 24 wherein the step of depositing a pair of shaped thermistor electrical conductors comprises the step of depositing each conductor of the pair of shaped thermistor electrical conductors in an interdigitated manner with the other electrical conductor.

28. The method of manufacturing a thick film thermistor according to claim 24 wherein the first support substrate and the second support substrate comprise flexible film substrates.
